(19) United States
(12) Patent Application Publication
(10) Pub. No.: US 2025/0328771 A1
(43) Pub. Date: Oct. 23, 2025

(54) SOFT PROMPT OPTIMIZATION

(71) Applicant: INTERNATIONAL BUSINESS MACHINES CORPORATION, ARMONK, NY (US)

(72) Inventors: Zhong Fang Yuan, Xi'an (CN); Tong Liu, Xi'an (CN); Li Juan Gao, Xi'an (CN); Xiang Yu Yang, Xi'an (CN)

(21) Appl. No.: 18/644,055

(22) Filed: Apr. 23, 2024

(51) Int. Cl. G06N 3/0895

(52) U.S. Cl. CPC G06N 3/0895

(57) ABSTRACT

An autoencoder for optimizing machine learning by soft prompting a machine learning language model (“MLLM”) trained on a corpus of unlabeled sample data for natural language classification. The autoencoder has a computer readable storage medium with program instructions embodied therewith. Execution of the program instructions by a computer processor causes a computing device to encode a query into a soft computer prompt corresponding to a target response from the MLLM. The soft computer prompt is embedded into a multidimensional prompt vector in a representation space of the unlabeled sample data. A minibatch of the unlabeled sample data is embedded into a plurality of multidimensional data vectors in the representation space. A contrastive loss is determined from the plurality of data vectors in relation to the prompt vector. Upon determining that the contrastive loss is nonzero, then the MLLM is trained to reduce the contrastive loss.

### BACKGROUND

### Technical Field

The present disclosure generally relates to machine learning, and more particularly, to computer devices and methods that improve machine learning by optimizing soft prompting to a machine learning language model (“MLLM”) through contrastive representation learning.

### Description of the Related Art

MLLMs such as large language models have revolutionized natural language processing by generating coherent and contextually relevant text responses to users' prompts. Recent advancements in soft prompting provide flexible cues, eliminating the need for rigidly structured prompts and cumbersome prompt engineering. This adaptability can be achieved by generating continuous cue embeddings that enhance the fluidity and adaptiveness of the user interaction paradigm. Apart from soft prompting, contrastive learning can be employed to discern subtle patterns and nuances in the sample data even without explicit labels. This can aid in extracting meaningful feature representations, thereby improving the MLLM's ability to generate coherent and context-sensitive responses. Reducing contrastive loss in the unlabeled sample data can serve to refine decision boundaries and increase decision margins.

### SUMMARY

According to an embodiment of the present disclosure, an autoencoder computer program product is provided for optimizing machine learning by soft prompting a machine learning language model (“MLLM”) trained on a corpus of unlabeled sample data for natural language classification. The autoencoder computer program product has a computer readable storage medium with program instructions embodied therewith. An execution of the program instructions by a computer processor causes a computing device to encode a query into a soft computer prompt corresponding to a target response from the MLLM. The soft computer prompt is embedded into a multidimensional prompt vector in a representation space of the unlabeled sample data. A minibatch of the unlabeled sample data is embedded into a plurality of multidimensional data vectors in the representation space. A contrastive loss is determined from the plurality of data vectors in relation to the prompt vector in the representation space. Upon determining that the contrastive loss is nonzero, then the MLLM is trained to reduce the contrastive loss.

In one embodiment, an autoencoder computer data structure is provided for optimizing machine learning by soft prompting an MLLM trained on a corpus of unlabeled sample data for natural language classification. The autoencoder data structure has an encoder configured to encode a query into a soft computer prompt corresponding to a target response from the MLLM. A computer readable storage medium has program instructions embodied therewith, such that an execution of the program instructions by a computer processor causes a computing device to encode a query into a soft computer prompt corresponding to a target response from the MLLM. The soft computer prompt is embedded into a multidimensional prompt vector in a representation space of the unlabeled sample data. A minibatch of the unlabeled sample data is embedded into a plurality of multidimensional data vectors in the representation space. The contrastive loss from the plurality of data vectors is determined in relation to the prompt vector in the representation space. Upon determining that the contrastive loss is nonzero, then the MLLM is trained to reduce the contrastive loss.

In one embodiment, a computer system is provided for optimizing machine learning by soft prompting an MLLM trained on a corpus of unlabeled sample data for natural language classification. The computer system has a processor, a computer-readable memory, a computer-readable tangible storage device, and program instructions stored on the computer-readable storage device for execution by a processor via the computer-readable memory. The computer system is configured to encode a query into a soft computer prompt corresponding to a target response from the MLLM. The soft computer prompt is embedded into a multidimensional prompt vector in a representation space of the unlabeled sample data. A minibatch of the unlabeled sample data is embedded into a plurality of multidimensional data vectors in the representation space. The contrastive loss from the plurality of data vectors is determined in relation to the prompt vector in the representation space. Upon determining that the contrastive loss is nonzero, then the MLLM is trained to reduce the contrastive loss.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block depiction of a computer hardware platform for an efficient and reliable soft prompt optimization engine, consistent with illustrative embodiments.

FIG. 2 illustrates an operating environment for the soft prompt optimization engine in FIG. 1, consistent with illustrative embodiments.

FIG. 3 is a functional block depiction of an operating environment for the soft prompt optimization engine in FIG. 1, consistent with illustrative embodiments.

FIG. 4 is a block depiction of a computer system for soft prompt optimization, consistent with illustrative embodiments.

FIG. 5 is a block depiction of an autoencoder computer data structure configured for encoding a query into an encoded prompt, consistent with illustrative embodiments.

FIG. 6 is a block depiction of workflow for prompting a machine learning language model (“MLLM”) to embed prompt vectors and data vectors in a multidimensional representation space, and for training the MLLM from responses to the prompting, consistent with illustrative embodiments.

FIG. 7 diagrammatically depicts a prompt vector and three sample data vectors in a representation space, consistent with illustrative embodiments.

FIG. 8 is a block depiction of a transformer model computing MLLM loss, consistent with illustrative embodiments.

FIG. 9 is a block depiction of an encoder embedding a prompt vector and sample data vectors in a representation space, consistent with illustrative embodiments.

FIG. 10 is a block depiction of a neural network computing contrastive loss, consistent with illustrative embodiments.

FIG. 11a diagrammatically depicts an autoencoder computer product for encoding a soft prompt, consistent with illustrative embodiments.

FIG. 11b diagrammatically depicts the autoencoder computer product of claim 11a encoding another soft prompt having a different configuration, consistent with illustrative embodiments.

FIG. 11c diagrammatically depicts the autoencoder computer product of claim 11a encoding another soft prompt having a different configuration, consistent with illustrative embodiments.

FIG. 12a diagrammatically depicts a prompt vector and an annular margin that includes a positive nearest neighbor in a minibatch of sample data in a representation space, consistent with illustrative embodiments.

FIG. 12b diagrammatically depicts the annular margin in FIG. 12a expanded to include a positive second nearest neighbor, consistent with illustrative embodiments.

FIG. 12c diagrammatically depicts pushing negative sample data to establish the annular margin with the positive second nearest neighbor, consistent with illustrative embodiments.

FIG. 13 is a flow chart depicting a method for soft prompt optimization, consistent with illustrative embodiments.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

In one embodiment of the present disclosure, a computer program product is provided for optimizing machine learning by soft prompting a machine learning language model (“MLLM”) trained on a corpus of unlabeled sample data for natural language classification. The autoencoder computer program product has a computer readable storage medium with program instructions embodied therewith. An execution of the program instructions by a computer processor causes a computing device to encode a query into a soft computer prompt corresponding to a target response from the MLLM. The soft computer prompt is embedded into a multidimensional prompt vector in a representation space of the unlabeled sample data. A minibatch of the unlabeled sample data is embedded into a plurality of multidimensional data vectors in the representation space. A contrastive loss is determined from the plurality of data vectors in relation to the prompt vector in the representation space. Upon determining that the contrastive loss is nonzero, then the MLLM is trained to reduce the contrastive loss. A technical advantage of reducing the contrastive loss is a smoothing of classification boundaries and an increasing of decision margins, making the soft computer prompt more robust.

In an embodiment, the execution of the program instructions further causes the computing device to inference a response to the soft computer prompt. An MLLM loss is determined by comparing the response to the target response. Upon determining the MLLM loss is non-zero, then the MLLM is trained to minimize the MLLM loss. A technical advantage of minimizing the MLLM loss is a smoothing of classification boundaries and an increasing of decision margins, making the soft computer prompt more robust.

In an embodiment, encoding the query includes allocating a computer programmable memory to a plurality of tokens. The query is divided into a plurality of query segments, each stored to one of the tokens in the plurality of tokens. One of the tokens is masked to withhold the corresponding query segment from the soft computer prompt. A technical advantage is elimination of the need for prompt engineering a prompt template and verbalizers.

In an embodiment, determining the contrastive loss includes embedding a copy of the prompt vector into a positive sample vector in the representation space. A sample data outside the minibatch is embedded into a negative sample vector in the representation space. A technical advantage is that these positive and negative sample vectors can be employed in self-supervised contrastive learning with a corpus of unlabeled sample data.

In an embodiment, the positive sample vector is an augmented copy of the prompt vector. A technical advantage is the augmented copy of the prompt vector produces a broader scope of similarity searching in the corpus of unlabeled sample data.

In an embodiment, encoding the query includes masking one of the tokens of the plurality of tokens to form a first encoder configuration. A first soft computer prompt is embedded with the first encoder configuration and set to the prompt vector. A different one of the tokens of the plurality of tokens is masked to form a second encoder configuration. A second soft computer prompt is embedded with the second encoder configuration and set to the positive sample vector. A technical advantage is an unlimited number of unique encoder configurations can be employed in the encoding.

In an embodiment, encoding the query includes masking one or more of the tokens of the plurality of tokens to form a first encoder configuration. A first soft computer prompt is embedded with the first encoder configuration and set to the prompt vector. A different one or more of the tokens of the plurality of tokens are masked to form a second encoder configuration. A second soft computer prompt is embedded with the second encoder configuration and set to the positive sample vector. A technical advantage is an unlimited number of unique encoder configurations can be employed in the encoding.

In an embodiment, the execution of the program instructions further causes the computing device to inference similarity of a selected data vector in the minibatch by a pairwise comparison to the positive sample vector and the negative sample vector. If the selected data vector is similar to the positive sample vector, then the selected data vector is set to a positive data sample. If the selected data vector is dissimilar to the positive sample vector, then the selected data vector is set to a negative data sample. A technical advantage is that pairwise comparison of the positive and negative sample vectors can be employed in self-supervised contrastive learning with a corpus of unlabeled sample data.

In an embodiment, the contrastive loss is based on a predetermined contrastive loss objective for a first positive data sample and a first negative data sample in the minibatch. A technical advantage is employing the contrastive loss objective without benefit of having classification labels for the data samples.

In an embodiment, the predetermined contrastive loss objective includes a boundary condition in the representation space for the first positive data sample and the first negative data sample. A technical advantage is the boundary can balance reducing contrastive loss with maintaining whatever anisotropy exists in the sample data distribution.

In an embodiment, the predetermined contrastive loss objective is a maximum value between zero and a contrastive representation state between the first positive data sample, the first negative data sample, and an annular boundary condition around the prompt vector. A technical advantage is the boundary can balance reducing contrastive loss with maintaining whatever anisotropy exists in the sample data distribution.

In an embodiment, the contrastive loss is determined by pushing the first negative data sample to establish an annular margin around the prompt vector. A technical advantage is the boundary can balance reducing contrastive loss with maintaining whatever anisotropy exists in the sample data distribution.

In one embodiment, an autoencoder apparatus is provided for optimizing machine learning by soft prompting a machine learning language model (“MLLM”) trained on a corpus of unlabeled sample data for natural language classification. The autoencoder apparatus has an encoder configured to encode a query into a soft computer prompt corresponding to a target response from the MLLM. A computer readable storage medium has program instructions embodied therewith, such that an execution of the program instructions by a computer processor causes a computing device to encode a query into a soft computer prompt corresponding to a target response from the MLLM. The soft computer prompt is embedded into a multidimensional prompt vector in a representation space of the unlabeled sample data. A minibatch of the unlabeled sample data is embedded into a plurality of multidimensional data vectors in the representation space. The contrastive loss from the plurality of data vectors is determined in relation to the prompt vector in the representation space. Upon determining that the contrastive loss is nonzero, then the MLLM is trained to reduce the contrastive loss. A technical advantage of reducing the contrastive loss is a smoothing of classification boundaries and an increasing of decision margins, making the soft computer prompt more robust.

In an embodiment, encoding the query includes allocating a computer programmable memory to a plurality of tokens. The query is divided into a plurality of query segments, each stored to one of the tokens in the plurality of tokens. One of the tokens is masked to withhold the corresponding query segment from the soft computer prompt. A technical advantage is elimination of the need for prompt engineering a prompt template and verbalizers.

In an embodiment, determining the contrastive loss includes embedding a copy of the prompt vector into a positive sample vector in the representation space. A sample data outside the minibatch is embedded into a negative sample vector in the representation space. A technical advantage is that these positive and negative sample vectors can be employed in self-supervised contrastive learning with a corpus of unlabeled sample data.

In an embodiment, the positive sample vector is an augmented copy of the prompt vector. A technical advantage is the augmented copy of the prompt vector produces a broader scope of similarity searching in the corpus of unlabeled sample data.

In an embodiment, encoding the query includes masking one or more of the tokens of the plurality of tokens to form a first encoder configuration. A first soft computer prompt is embedded with the first encoder configuration and set to the prompt vector. A different one or more of the tokens of the plurality of tokens are masked to form a second encoder configuration. A second soft computer prompt is embedded with the second encoder configuration and set to the positive sample vector. A technical advantage is an unlimited number of unique encoder configurations can be employed in the encoding.

In an embodiment, the execution of the program instructions further causes the computing device to inference similarity of a selected data vector in the minibatch by a pairwise comparison to the positive sample vector and the negative sample vector. If the selected data vector is similar to the positive sample vector, then the selected data vector is set to a positive data sample. If the selected data vector is dissimilar to the positive sample vector, then the selected data vector is set to a negative data sample. A technical advantage is that pairwise comparison of the positive and negative sample vectors can be employed in self-supervised contrastive learning with a corpus of unlabeled sample data.

In an embodiment, the contrastive loss is determined by pushing a first negative data sample to establish an annular margin around the prompt vector. A technical advantage is the boundary can balance reducing contrastive loss with maintaining whatever anisotropy exists in the sample data distribution.

In one embodiment, a computer system is provided for optimizing machine learning by soft prompting a machine learning language model (“MLLM”) trained on a corpus of unlabeled sample data for natural language classification. The computer system has a processor, a computer-readable memory, a computer-readable tangible storage device, and program instructions stored on the computer-readable storage device for execution by a processor via the computer-readable memory. The computer system is configured to encode a query into a soft computer prompt corresponding to a target response from the MLLM. The soft computer prompt is embedded into a multidimensional prompt vector in a representation space of the unlabeled sample data. A minibatch of the unlabeled sample data is embedded into a plurality of multidimensional data vectors in the representation space. The contrastive loss from the plurality of data vectors is determined in relation to the prompt vector in the representation space. Upon determining that the contrastive loss is nonzero, then the MLLM is trained to reduce the contrastive loss. A technical advantage of reducing the contrastive loss is a smoothing of classification boundaries and an increasing of decision margins, making the soft computer prompt more robust.

To better understand the features of the present disclosure, it may be helpful to discuss known architectures. To that end, the following detailed description illustrates various aspects of the present disclosure by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

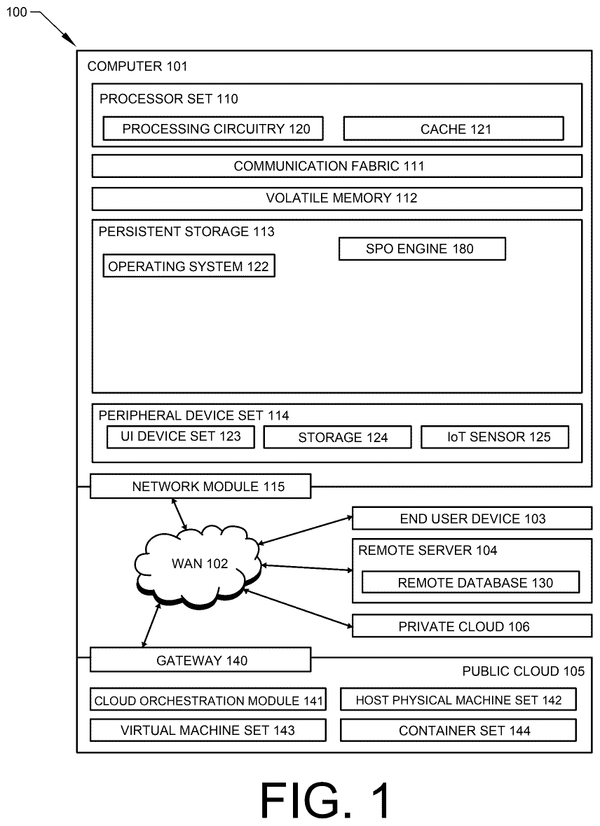

Referring to FIG. 1, computing environment 100 includes an example of an environment for the execution of at least some of the computer code involved in performing the inventive methods, including a soft prompt optimization (“SPO”) engine 180. In addition to SPO engine 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and SPO engine 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the SPO engine 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the SPO engine 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

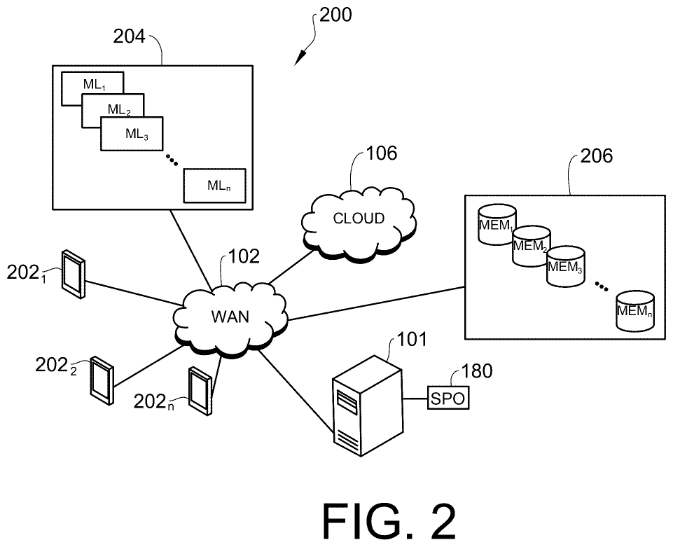

FIG. 2 conceptually depicts the computer 101 of FIG. 1 employed as a centralized computer server, as part of a distributed computing system 200 configured for soft prompt optimization in accordance with embodiments of this technology. The server (e.g., computer) 101 can communicate via the WAN 102 with remote devices such as with remote user devices 202, and with remote computing resources.

The WAN 102 can be, but is not limited to, a local area network (“LAN”), a virtual private network (“VPN”), a cellular network, the internet, combinations thereof, and the like. For example, the WAN 102 can include a mobile network that is communicatively coupled to a private network, sometimes referred to as an intranet that provides various ancillary services, such as communication with various application stores, libraries, and the internet.

The user devices 202 can send and receive information throughout the WAN 102. They can include stationary computing devices such as desktop computers and enterprise computing systems, as well as portable computing devices such as laptop computers, portable handsets, a mobile phone computing device, a vehicle communications system, a smart appliance such as a smart television or projector, tablet computers, personal digital assistants (“PDAs”), a wearable computing device such as a smart watch, glasses, virtual or augmented reality computing devices, and the like.

In these embodiments, the remote computing resources available to the server (e.g., computer) 101 include any number of computer machine learning resources 204, and computer memory resources 206 for storing data structures, programming instructions, sample data, and the like. “Machine learning” broadly describes a function of an electronic system that learns from data. A machine learning system, engine, or module can include a trainable machine learning algorithm stored in computer memory that can be trained, such as in a cloud environment, to learn functional relationships between inputs and outputs that are currently unknown.

Machine learning can be utilized to solve a variety of technical issues (e.g., learning previously unknown functional relationships) in connection with technologies such as, but not limited to, machine learning technologies, time-series data technologies, data analysis technologies, data classification technologies, data clustering technologies, trajectory/journey analysis technologies, medical device technologies, collaborative filtering technologies, recommendation system technologies, signal processing technologies, word embedding technologies, topic model technologies, image processing technologies, video processing technologies, audio processing technologies, and/or other digital technologies.

Machine learning can be utilized to solve a variety of technical issues (e.g., learning previously unknown functional relationships) in connection with technologies such as, but not limited to, machine learning technologies, time-series data technologies, data analysis technologies, data classification technologies, data clustering technologies, trajectory/journey analysis technologies, medical device technologies, collaborative filtering technologies, recommendation system technologies, signal processing technologies, word embedding technologies, topic model technologies, image processing technologies, video processing technologies, audio processing technologies, and/or other digital technologies.

Accordingly, the computer 101 has a specialized processing unit such as the SPO engine 180 and the like for carrying out computations related to optimizing machine learning. More particularly, without limitation, the specialized processing unit automatically and consistently performs soft prompt optimization. The computer system 200 is thereby specifically configured to provide technical improvements to data systems, machine learning systems, artificial intelligence systems, and systems of data analysis systems such as but not limited to data classification systems, data regression systems, data batching and clustering systems, and the like. The optimization can further provide one or more inferences, provide one or more predictions, and/or determine one or more relationships among the data. For example, optimization as described herein can model one or more inferences and/or predictions and/or may determine one or more relationships amongst the variables analyzed in the data. Machine learning predicts outputs, e.g., probabilities, from historical data. Such optimized machine learning helps with downstream decision making, even with such downstream decision making that is automated.

The machine learning resources 204 can employ any suitable ML based techniques, statistical-based techniques and/or probabilistic-based techniques. For example, the ML resources can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, and the like. For example, the ML resources can perform a set of clustering ML computations, a set of logistic regression ML computations, a set of decision tree ML computations, a set of random forest ML computations, a set of regression tree ML computations, a set of least square ML computations, a set of instance-based ML computations, a set of support vector regression ML computations, a set of k-means ML computations, a set of spectral clustering ML computations, Gaussian mixture model ML computations, a set of regularization ML computations, a set of rule ML computations, a set of Bayesian ML computations, a set of deep Boltzmann computations, a set of deep belief network computations, a set of convolution neural network computations, a set of stacked auto-encoder computations and/or a set of different ML computations.

Accordingly, the distributed computing system 200 generally facilitates optimizing machine learning in accordance with one or more embodiments illustratively described herein. For example, the optimizations can be related to high-speed parallel training trial systems, an artificial intelligence system, a collaborative filtering system, a recommendation system, a signal processing system, a word embedding system, a topic model system, an image processing system, a data analysis system, a media content system, a video-streaming service system, an audio-streaming service system, an e-commerce system, a social network system, an internet search system, an online advertisement system, a medical system, an industrial system, a manufacturing system, and/or another digital system. The system can employ hardware and/or software to solve problems that are highly technical in nature, that are not abstract and that cannot be performed as a set of mental acts by a human.

For simplicity of explanation, the specialized-computer-implemented methods are depicted and described as a series of acts. It is to be understood and appreciated that the subject innovation is not limited by the acts illustrated and/or by the order of acts. That is, for example, acts can occur in various orders and/or concurrently, and with other acts not presented and described herein. Furthermore, not all expressly disclosed acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from a computer-readable device or storage media.

The system can employ hardware and/or software to solve problems that are highly technical in nature, that are not abstract and that cannot be performed as a set of mental acts by a human. One or more embodiments of the system can also provide technical improvements to a computer processing unit associated with a ML process by improving processing performance of the computer processing unit, reducing computing bottlenecks of the computer processing unit, improving processing efficiency of the computer processing unit, and/or reducing an amount of time for the computer processing unit to perform the ML process.

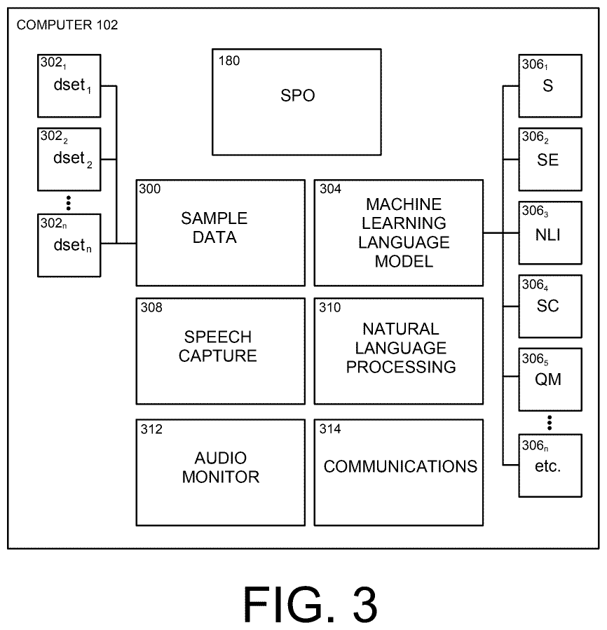

FIG. 3 is a block depiction of an illustrative operating environment for the SPO engine 180. For the sake of clarity, the components of FIG. 3 can be physically located anywhere, in part or in whole, that is accessible via the WAN 102, including the server (e.g., computer) 101, the remote machine learning resources 204 and memory resources 206, cloud-based resources 106, and the like. For example, one or more components of FIG. 3 can be implemented on one or more computing devices and/or systems other than the computer 101, that are in network communication with the computer 101. Each of the other computing devices and/or systems can have computer memories for data storage and software/firmware applications, processors for accessing data and executing applications, and other components that facilitate network communications. In other words, the SPO 180 can be executed by one or more distributed computing devices across multiple remote locations. Thus, the SPO 180 can be implemented as, for example, computer programs running on one or more computers running in one or more locations that are coupled to each other through a network.

In illustrative implementations, the computer 101 is a specialty computer configured to automatically engage in a user's communication session. For example, the computer 101 can monitor the contents of an audio stream during the user's communication session, and/or monitor the contents of user-provided inputs during the user's communication session. For example, in response to certain content the computer 101 can execute certain predefined routines. In other examples, the computer 101 can utilize speech recognition resources to convert the user's spoken words into understandable text language and respond to the user text accordingly in text language. In some embodiments, as discussed below, the computer 101 can thereby identify when a computer transaction has been requested during a user communication, and in response execute the SPO engine 180.

In these illustrative embodiments, the SPO engine 180 can access a sample data block 300 and a machine learning language model block 304. This enables selectively processing any of a number of datasets 302, such as can be indexed in computer registers 302₁, 320₂ . . . 302ₙ. Any desired dataset can be individually indexed and processed during a soft prompt session. The datasets 302 can be organized into different epochs, tuning parameters, classifications, and so on.

Block 304 gives the SPO engine 108 access to one or more ML models that can be trained to perform various tasks 306. For example, the ML model(s) can be trained for sentiment analysis 306₁, for sentence equivalence 306₂, for natural language inference 306₃, for subjectivity classification 306₄, for question matching 306₅, and the like. The SPO 180 can access the block 304 such as to obtain inference services from historical data, and/or to further train the ML model(s) with the same, with historic, and/or with new sample data.

A speech capture block 308 can be configured to capture the user's speech such as via a microphone. It can convert the captured audio content such as into text language (“STT”), and/or it can convert text language into audio content (“TTS”). A natural language processing block 310 can receive free-form language input and generate annotated output. For instance, the block 310 can include a speech tagger configured to annotate terms with grammatical information. The block 310 can also or alternatively include an entity tagger configured to annotate the terms with entity references, such as references to people, places, organizations, and the like. The block 310 can also or alternatively include a dependency parser configured to annotate terms with syntactic relationships. The block 310 can also or alternatively include a coreference resolver configured for contextual groupings. These components of the block 310 can cross-rely on the generated annotations. For example, the entity tagger can rely on annotations by the corereference resolver, and so on.

An audio stream monitor 312 can be configured to monitor the incoming and/or outgoing portions of an audio stream during a user's communication session. Furthermore, the SPO 180 can leverage a communications block 314 enabling efficient and consistent network communications. For example, the communications block 314 can be configured to implement and supervise wired communication, such as Ethernet communication and/or telephone landline communication, and wireless communication, such as WiFi communication, Bluetooth communication, cellular voice and/or data communication, Near-Field Communication (NFC), and the like.

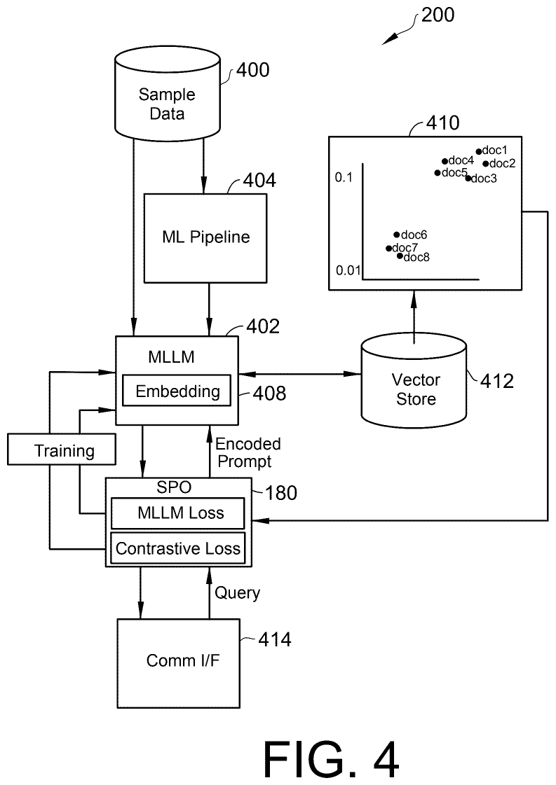

FIG. 4 is a functional block depiction of the distributed computing system 200 for soft prompting a machine learning language model (“MLLM”) 402, which can be a large language model, a foundation model, and the like. The SPO engine 180 can be configured to automatically optimize machine learning during a prompt session with the MLLM 402. Although the disclosed embodiments are directed to applying machine learning to natural language processing, alternative equivalent embodiments can be directed to other types of machine learning such as but not limited to those directed to image classification, computer vision, gaming, and the like.

The distributed computing system 200 can include an ML pipeline 404 configured for collecting and conditioning datasets 302 from a set of unlabeled sample data 400 used to pre-train the MLLM 402. The quality of training the MLLM 402 depends on the amount and quality of the sample data 400. The ML pipeline 404 can function on one end to parse training datasets from the sample data 400, such as for high-speed parallel training trials in any desired number of machine learning models. The ML pipeline 404 can also parse a selected minibatch from the sample data 400. On the other end, the ML pipeline 404 can function to supply the datasets 302 to high-speed parallel training trials running on one or more ML models, as well as to other computer processing functions associated with embodiments of this disclosure. In between, the ML pipeline 404 can function to preprocess the data sets into proper form for reliable training and other processing.

At the first end, the sample data 400 can be stored in one or multiple computer memories. Extracting datasets from the sample data 400 can involve many formatting operations, such as joining data tables together and the like. Preprocessing the data sets can involve many transformative operations, such as resizing images, decoding videos, augmenting data, and the like. The preprocessing can include multiplexing a feature data stream and a label data stream into a unified complex data stream to the training trials. In an example in which the features include video images, the labels can be cross-identifications for the images, and the like. This label processing can further include transforming integer values to tensor values for performing similarity and classification modeling. Duplicate data can be discarded, and incomplete or erroneous data can be supplemented and/or corrected. The sample data 400 can also be randomized before parsing it to reduce the adverse effects of sampling variations. The sample data 400 can also be divided into mutually exclusive portions. The largest portion is typically for a training dataset, whereas smaller portions can be used for a test dataset, a tuning dataset, and the like. Any dataset can be copied and archived in computer memory for subsequent processing.

The MLLM 402 can be any of a number of different ML models that can be used with machine learning. Generally, ML models well suited for natural language processing include bidirectional encoder representations from transformers (“BERT”) and generative pre-trained transformers (“GPT”). Other ML resources in the computer system 200 can employ any suitable ML based techniques, statistical-based techniques and/or probabilistic-based techniques. For example, ML resources can employ expert systems, fuzzy logic, support vector machines (“SVMs”), hidden Markov models (HMMs), greedy search algorithms, rule-based systems, Bayesian models (e.g., Bayesian networks), neural networks, other non-linear training techniques, data fusion, utility-based analytical systems, and the like. For example, ML resources can perform a set of clustering ML computations, such as k nearest neighbors (“kNN”) and/or approximate nearest neighbors (“ANN”) computational blocks, a set of linear and/or logistic regression ML computations, a set of decision tree ML computations, a set of random forest ML computations, a set of regression tree ML computations, a set of least square ML computations, a set of instance-based ML computations, a set of support vector regression ML computations, a set of k-means ML computations, a set of spectral clustering ML computations, Gaussian mixture model ML computations, a set of regularization ML computations, a set of rule ML computations, a set of Bayesian ML computations, a set of deep Boltzmann computations, a set of deep belief network computations, a set of convolution neural network computations, a set of stacked auto-encoder computations and/or a set of different ML computations.

The MLLM 402 can have an embedding encoder 408 configured to embed the sample data 400 in various different native formats, such as documents, text, classifications and sub-classifications and the like, into multidimensional data vectors in a representation space. The SPO engine 180 controls the embedding by soft prompting the MLLM 402. In an embodiment, the representation space can be a Euclidean embedding space 410, although the contemplated embodiments are not so limited. The embedding encoder 408 can include a number of sentence transformers that are configured to preserve the semantic content of the sample data 400 in the complex, multi-dimensional data vectors, consistent with illustrative embodiments.

FIG. 4 depicts a simplified two-dimensional representation of several documents encoded into sample data vectors in the embedding space 410. The closer together adjacent sample data vectors are in the embedding space 410, the more similar is the linguistic content of the documents they represent. For example, the sample data vector embeddings indicate that the linguistic content of doc1 is more similar to doc2 than it is to doc8. The similarity of two sample data vectors is related to the inner product of the angle between them, which can be computed such as in terms of cosine similarity. Thus, groups of similar documents form data vector clusters. Particularly, in this example five data vectors form a first cluster (doc1, doc2, doc3, doc4, doc5) and three data vectors form a second cluster (doc6, doc7, doc8).

A vector store 412 can be used to index, store, and retrieve the data vectors so they only have to be computed once for subsequent processing. The vector store 412 can also perform valuable resource functions such as computing distances between data vectors, approximate nearest neighbor (“ANN”) computations for data vectors, and the like. In more complex applications the vector store 412 can be a vector database, such as commercially available vector databases marketed under Pinecone®, Weaviate®, Chroma®, and other brands. In less complex applications the vector store 412 can be a vector library, such as commercially available vector libraries marketed under FAISS®, ScaNN®, ANNOY®, and other brands.

The SPO engine 180 can respond to a user's query received via a communications interface 414. The SPO engine 180 controls encoding the query into an encoded prompt for vector embedding by the MLLM 402. The SPO engine 180 also controls training the MLLM 402 for both MLLM loss and for contrastive loss of the sample data 400 in the representation space 410.

The SPO engine 180 is thereby specifically configured to provide technical improvements to data systems, machine learning systems, artificial intelligence systems, and data analysis systems such as but not limited to data classification systems, data regression systems, data batching and clustering systems, and the like. The prompt session optimization of this disclosure can further provide one or more inferences, provide one or more predictions, and/or determine one or more relationships among the data. For example, optimization as described herein can model one or more inferences and/or predictions and/or may determine one or more relationships amongst the variables analyzed in the data. Machine learning predicts outputs, e.g., probabilities, from historical data. Such optimized machine learning helps with downstream decision making, even with such downstream decision making that is automated.

Accordingly, the SPO engine 180 generally facilitates optimizing machine learning in accordance with one or more embodiments illustratively described herein. For example, the optimizations can be related to high-speed parallel training trial systems, an artificial intelligence system, a collaborative filtering system, a recommendation system, a signal processing system, a word embedding system, a topic model system, an image processing system, a data analysis system, a media content system, a video-streaming service system, an audio-streaming service system, an e-commerce system, a social network system, an internet search system, an online advertisement system, a medical system, an industrial system, a manufacturing system, and/or another digital system. The system can employ hardware and/or software to solve problems that are highly technical in nature, that are not abstract and that cannot be performed as a set of mental acts by a human.

For simplicity of explanation, the specialized-computer-implemented methods and computer program products are depicted and described as a series of acts. It is to be understood and appreciated that the subject innovation is not limited by the acts illustrated and/or by the order of acts. That is, for example, acts can occur in various orders and/or concurrently, and with other acts not presented and described herein. Furthermore, not all expressly disclosed acts are necessarily required to implement the computer-implemented methodologies and products in accordance with the disclosed subject matter. In addition, those skilled in the art will understand and appreciate that the computer-implemented methodologies and products could alternatively be represented as a series of interrelated states via a state diagram or events. Additionally, it should be further appreciated that the computer-implemented methodologies disclosed herein and throughout this specification are capable of being stored on an article of manufacture to facilitate transporting and transferring such computer-implemented methodologies to computers. The term article of manufacture, as used herein, is intended to encompass a computer program accessible from a computer-readable device or storage media.

The system can employ hardware and/or software to solve problems that are highly technical in nature, that are not abstract and that cannot be performed as a set of mental acts by a human. One or more embodiments of the system can also provide technical improvements to a computer processing unit associated with a ML process by improving processing performance of the computer processing unit, reducing computing bottlenecks of the computer processing unit, improving processing efficiency of the computer processing unit, and/or reducing an amount of time for the computer processing unit to perform the ML process.

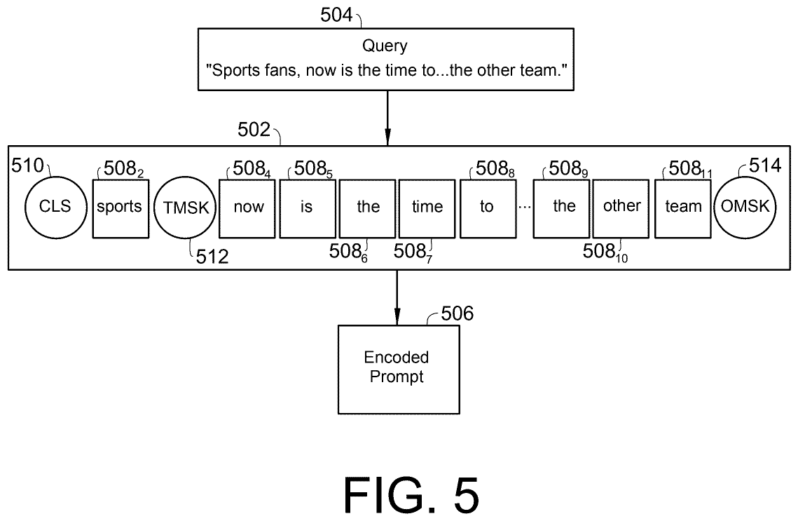

FIG. 5 is a block depiction of an autoencoder computer data structure 502 configured for encoding a user's query 504 into a computer-encoded prompt 506. The query 504 can be electronically transmitted, such as via a written communication or a verbal communication and the like. The autoencoder data structure 502 allocates a computer programmable memory to a plurality of tokens 508. The query 504 can be divided into a plurality of query segments, each stored in one of the tokens 508. For example, the term “sports” in the query 504 is stored to the second token 508₂, and so on. The autoencoder data structure 502 also includes special tokens. A classification token “CLS” 510 serves as an input notification for the appended string. A target mask “TMSK” token 512 is a mask symbol replacing the query segment in the encoded prompt 506. In this example, the TMSK token 512 masks the query segment “fans,” thereby withholding that query segment from the encoded prompt 506. An output mask “OMSK” token 512 is a mask replacement symbol for an output of the autoencoder 502.

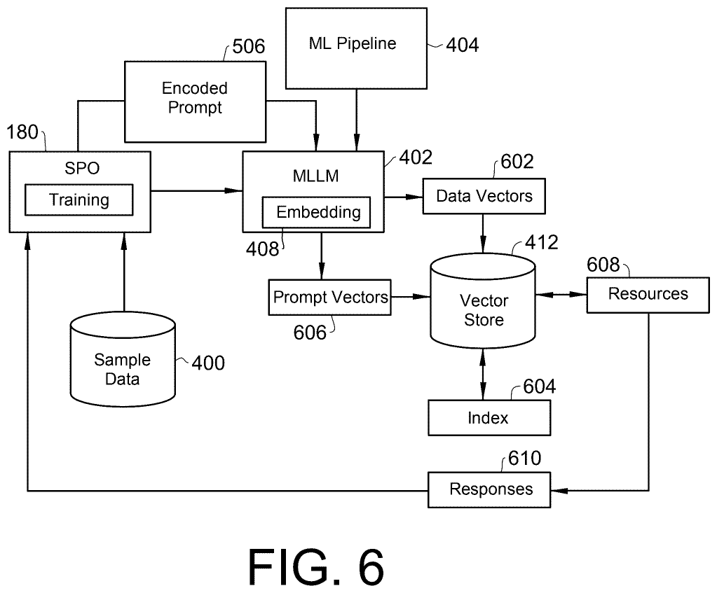

FIG. 6 is a high-level block depiction of a workflow in generating responses to the encoded prompts 506, such as in forming, indexing, and searching response vector embeddings. The ML pipeline 404 supplies pre-processed datasets of the sample data 400 to the MLLM 402, such as documents, text, categories and the like. The MLLM 402 embeds the sample data 400 into multidimensional data vectors 602 that can be referenced by an index 604. The index 604 is a data structure storing metadata for the data vectors 602 in a computer memory, such as in a random-access memory. In this way the vector store 412 is configured to enable fast, reliable, and low-overhead computations with the stored data vectors 602.

After the data vectors 602 are stored in the index 604, a user can process them by sending soft computer prompts to the MLLM 402 such as via the Comm I/F 414. The SPO 180 can encode the queries into encoded prompts 506 to the MLLM 402. In response, the MLLM 402 can embed the encoded prompts 506 into multidimensional prompt vectors 606 in the representation space, similar to embedding the sample data vectors 602. The vector store 412 can thereafter execute search algorithms with the support of resources 608 stored in computer memory, such as computed vector distances, ANN values and the like, to generate responses 610 to the user's soft prompts. The SPO 180 can then use the responses 610 and the sample data 400 for training the MLLM 402.

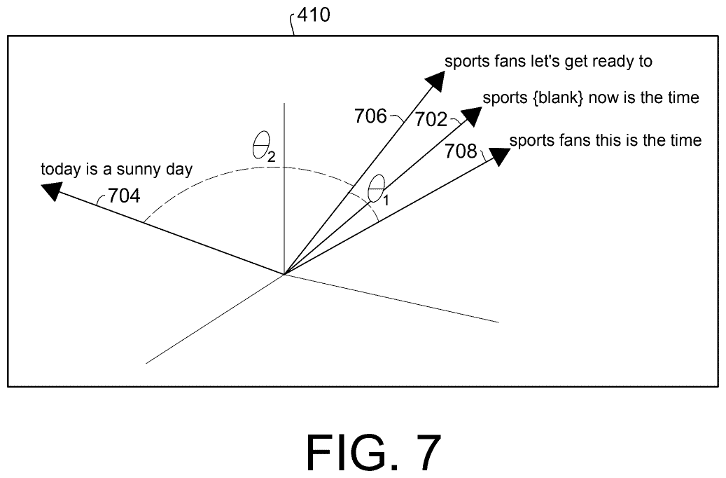

FIG. 7 continues this example, by the MLLM 402 embedding the query 504 into a multidimensional prompt vector 702 in the representation space of the unlabeled sample data. The SPO 180 can then control selecting a minibatch of sample data in closest proximity to the prompt vector 702. The SPO 180 can then control embedding the minibatch of sample data into multidimensional data vectors 704, 706, 708. This provides a few contrastive learning opportunities. For one, the inner product θ₁ between data vector 706 and data vector 708 is greater than the inner product θ₂ between data vector 702 and data vector 704. This means data vectors 706, 708 are more similar to each other than either is similar to data vector 704. For another, the prompt vector 702 is clustered with the data vectors 706, 708 meaning they are similar to each other, perhaps within the same classification such as the same context. This inferenced contrastive learning is without regard to data classification though to the extent that the minibatch contains unlabeled sample data.

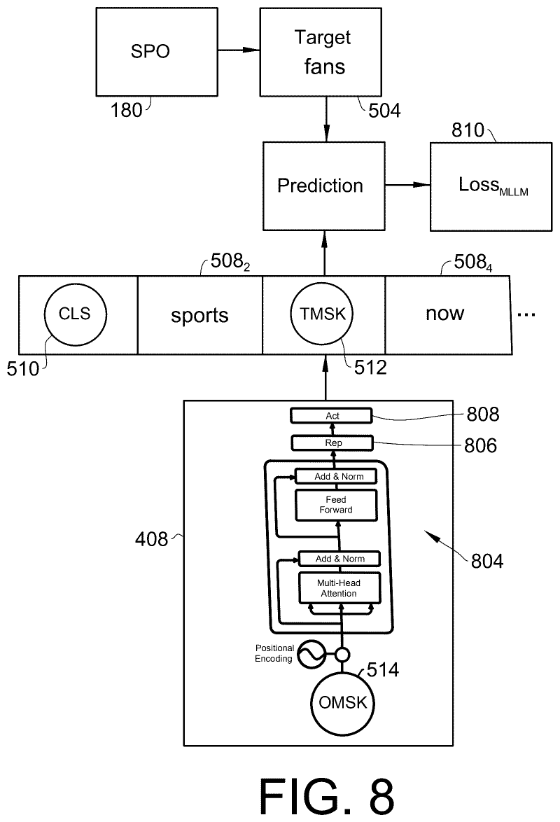

FIG. 8 is a block depiction of an illustrative embodiment for determining MLLM loss. In this example, the MLLM's embedding encoder 408 can include a sentence transformer model 804 as depicted. The embedding encoder 408 computes embeddings in response to the OMSK token 514, and the transformer model 804 computes an individual output from the embeddings for each of the tokens in the encoded prompt 506. The output includes a linear representation vector 806 that can be normalized by an activation function 808, such as by a Softmax function into a probability distribution. In this example, the output to the third token, TMSK token 512, is a prediction for the query segment that is withheld from the encoded prompt 506 by the TMSK token 512. The SPO 180 can control computing the MLLM loss in terms of the difference between the prediction and the target query segment (“fans”). The SPO 180 can then control training the MLLM 402 to minimize the MLLM loss.

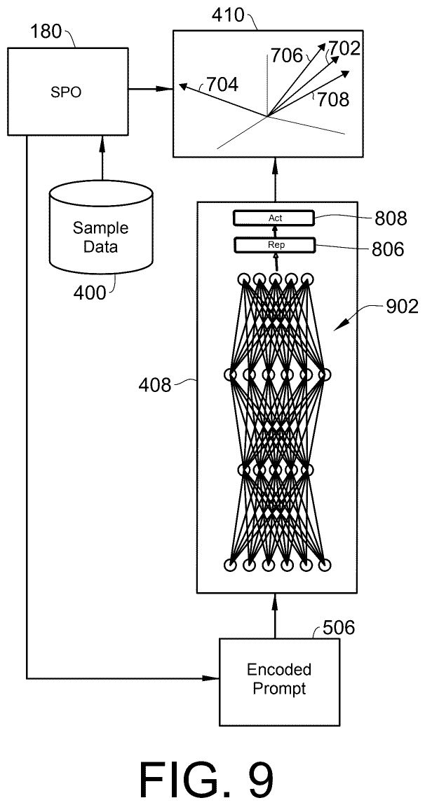

FIG. 9 is a block depiction of embedding the multidimensional vectors in the representation space 410. The embedding encoder 408 can include a neural network 902 configured for deep learning. The sentence transformer model 804 can be formed by hidden layers of the neural network 902. Furthermore, the SPO engine 180 can input the encoded prompt 506 to the neural network 902, then control embedding the multidimensional prompt vector 702 in the representation space 410. The SPO engine 180 can then access the sample data 400 to control selecting the minibatch of data samples in closest proximity to the prompt vector 702 and embedding the data samples into multidimensional data vectors 704, 706, 708 in the multidimensional representation space 410.

This gives the SPO engine 180 awareness of a contrastive representation state of the prompt vector 702 within the minibatch of data vectors 704, 706, 708. Although classifications of the data vectors 704, 706, 708 are unavailable to the extent the minibatch contains unlabeled sample data, the representation state nonetheless provides contrastive information that the data vectors 704, 706, 708 are somewhat related to each other and to the prompt vector 702. For example, the vector representations are such that similar data samples have similar representations and dissimilar data samples have dissimilar representations. The SPO engine 180 can control inferencing these similarity representations relative to the prompt vector 702 as a basis for determining any contrastive loss in the minibatch.

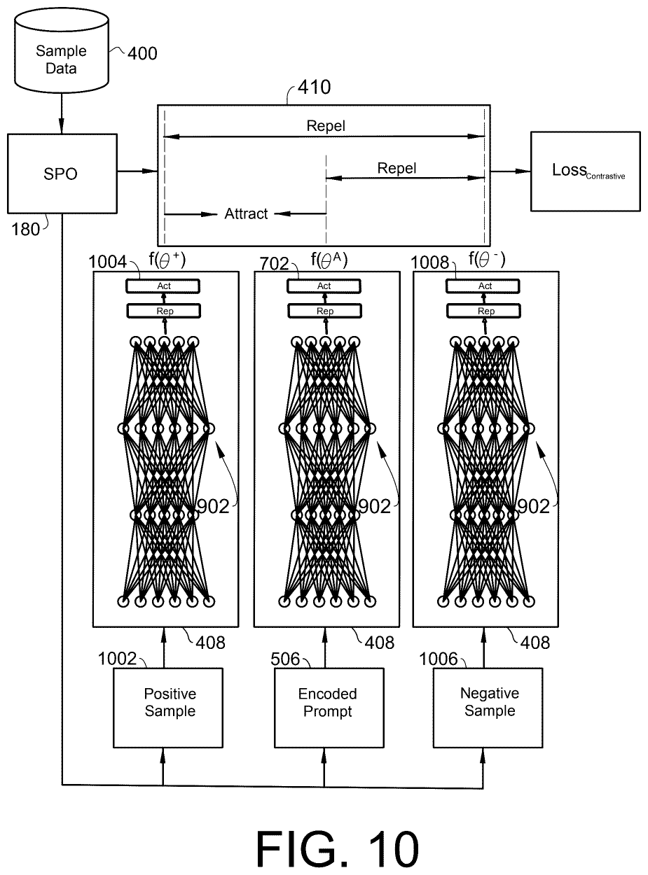

FIG. 10 illustrates a one-shot method of inferencing similarities for the data vectors in the minibatch. This method pre-trains the neural network 902 on the unlabeled sample data 400, then uses the pre-trained neural network 902 to extract feature vectors that can be compared to the data vectors for similarity. According to this example, in a first epoch the encoded prompt 506 can be input to the neural network 902 to embed a representation of the prompt vector 702. In a second epoch, a positive sample 1002 that is similar to the encoded prompt 506 can be input to the neural network 902 to embed a representation of a multidimensional positive sample vector 1004. In a third epoch, a negative sample 1006 that is dissimilar to the encoded prompt 506 can be input to the neural network 902 to embed a representation of a multidimensional negative sample vector 1008. The data vectors in the minibatch can then be discriminated by a pairwise comparison to the positive sample vector 1004 and the negative sample vector 1008. If a data vector is similar to the positive sample vector 1004 then it is set to a positive data sample, whereas if the data vector is dissimilar to the positive sample vector 1004 then it is set to a negative data sample.

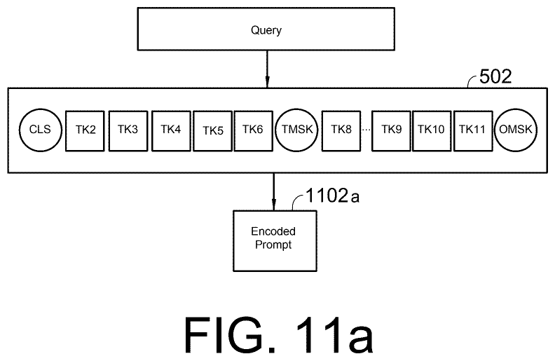

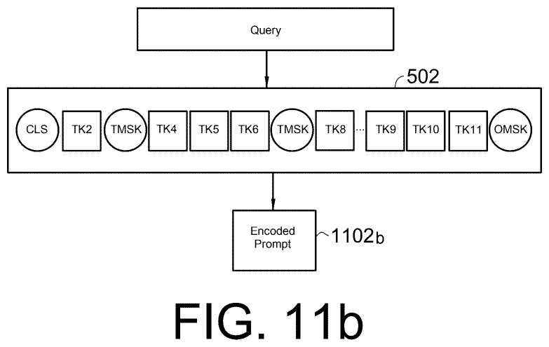

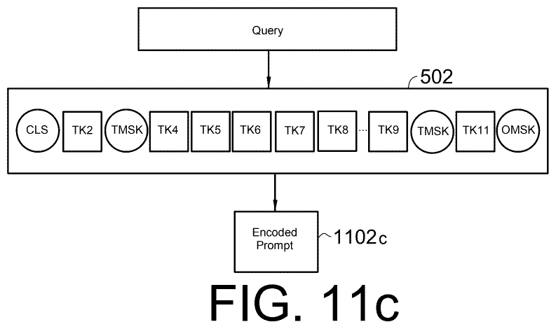

In one embodiment the positive sample 1002 can simply be a copy of the encoded prompt 506. However, this results in the narrowest possible scope of pairwise comparisons and will yield the fewest possible positive samples in the minibatch. To increase the scope of pairwise similarity, the positive sample 1002 can instead be an augmented copy of the encoded prompt 506. For example, recall that the encoded prompt 506 masks the third token corresponding to the query segment “fans.” That defines a first prompt encoder configuration. In one embodiment, FIG. 11a depicts an augmented positive sample can be obtained by changing the prompt autoencoder 502 to a second configuration. This produces a different encoded prompt 1102a by masking the seventh token corresponding to the query segment “time,” instead of masking the third token. This augmentation can be applied by masking any one of the tokens in the autoencoder 502 for encoding the encoded prompt 506, and by masking a different any one of the tokens in the autoencoder 502 for encoding a different encoded prompt 1102a for the positive sample 1002. FIGS. 11b and 11c extend this augmentation to cases where two or more tokens can be masked. For example, FIG. 11b depicts a third encoder configuration in which the third and seventh tokens are masked by the TMSK token 512. FIG. 11c depicts a fourth encoder configuration in which the seventh and tenth tokens are masked.

Returning to FIG. 10, the negative sample 1006 can be selected from sample data outside the minibatch, and thus less proximate to the prompt vector 702 than all the data vectors in the minibatch. The dissimilarity of the negative sample vector 1008 will be directly related to the representation space distance from the selected data sample to the minibatch. In alternative embodiments, the negative sample 1006 can be a labeled sample data such as in a test dataset.

Similarity can be computed in terms of comparing the representation space distance between the prompt vector 702 and the positive sample vector 1004, in comparison to the representation space distance between the prompt vector 702 and the negative sample vector 1008. Since the prompt vector 702 is used in computing both distances, it will sometimes be referred to as the “anchor.” The representation space distance between the prompt vector 702 and the positive sample vector 1004 is given by:

$${d}^{+} = {‖ f ( {θ}^{+} ) - f ( {θ}^{A} ) ‖}^{2} .$$

Similarly, the representation space distance between the prompt vector 702 and the negative sample vector 1008 is given by:

$${d}^{-} = {‖ f ( {θ}^{A} ) - f ( {θ}^{-} ) ‖}^{2}$$

Contrastive loss can be computed by pairwise comparisons of individual data samples in the minibatch to these positive and negative representation space distances. An individual data sample in the minibatch will be considered a positive sample if its embedded data vector is similar to the positive sample vector 1004, not the negative sample vector 1008. For purposes of this disclosure and meaning of the appended claims, the term “similar” means the closest sample vector to the data sample vector. That is, the data sample vector is set to be similar to the positive sample vector if the data sample vector is closer to the positive sample vector than it is to the negative sample vector. Likewise, the individual data sample in the minibatch will be considered a negative sample if its embedded data vector is more similar to the negative sample vector 1008 than the positive sample data vector 1004. Again, this means the data sample vector is closer to the negative sample vector than it is to the positive sample vector. The similarity values can be computed in relation to comparative inner products such as in terms of cosine similarities.

So, for a given minibatch of data samples x₁, x₂, . . . x_{N}, first the data samples can be embedded with f(θ) into respective multidimensional data vectors z₁, z₂, . . . z_{N}. Then contrastive loss can be reduced by maintaining the inner product between the anchor zᵢ with respect to individual positive data samples zⱼ₍ᵢ₎ while decreasing the inner product for all else:

$${ℒ}_{contrastive} = - {\sum }_{i ∈ I} \frac{log ( exp ( {z}_{i} \cdot {z}_{j ( i )} ) )}{{\sum }_{a ∈ A ( i )} exp ( {z}_{i} \cdot {z}_{a} )}$$

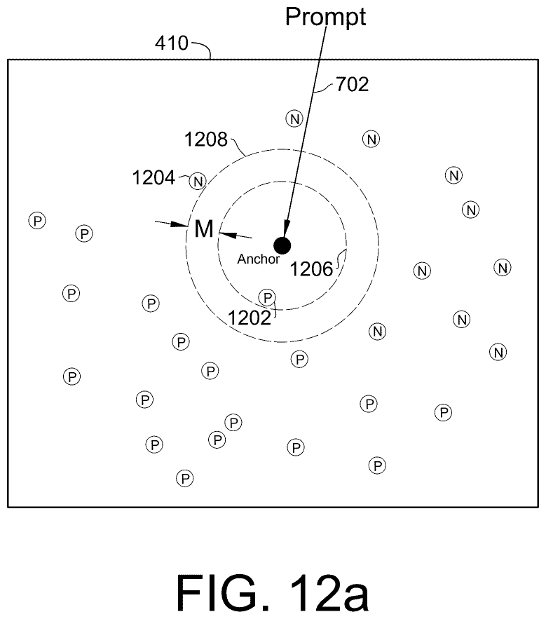

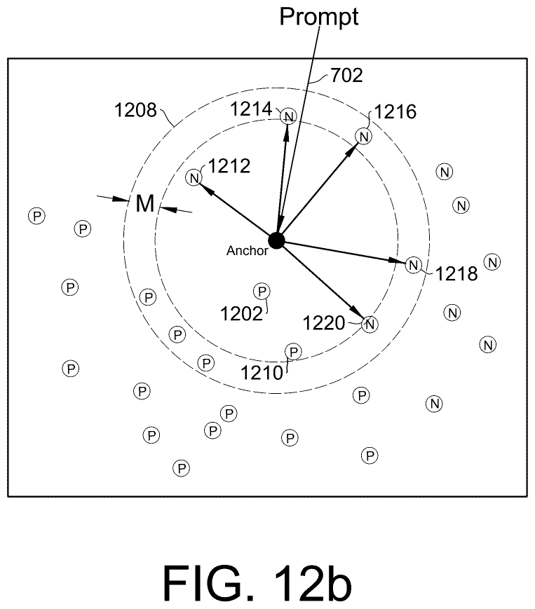

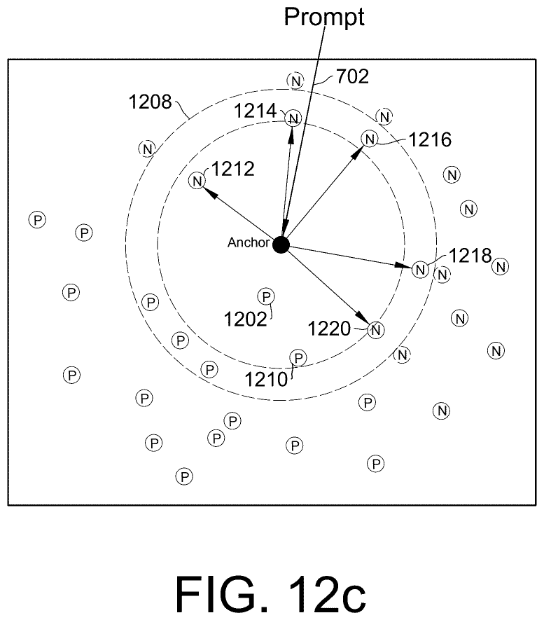

FIGS. 12a-12c depict reducing a contrastive state of the prompt vector 702 within the minibatch of sample data in the representation space 410. The sample data have been pairwise compared to the positive sample vector 1004 and the negative sample vector 1008 in order to distinguish positive data sample vectors (denoted by “P”) from negative data sample vectors (denoted by “N”). Contrastive loss can be reduced according to a predetermined loss objective for a positive data sample vector 1202 and a negative data sample vector 1204. The loss objective in this illustrative embodiment balances contrastive loss reduction with preserving whatever anisotropic distribution of the data samples exists in the representation space 410. In doing so, an annular boundary condition can be established around the prompt vector 702. The annular boundary condition can be defined by an inner radius (“Rᵢ”) 1206 and an outer radius (“Rₒ”) 1208. In this example, Rᵢ 1206 can be initially defined to include the nearest positive sample vector 1202 to the prompt vector 702. Rₒ 1208 can be defined to exclude the nearest negative sample vector 1204 to the prompt vector 702. A radial difference between Rₒ and Rᵢ can define a margin (“M”). The M can be compared to a predetermined minimum and/or maximum margin and adjusted accordingly.

In other contemplated embodiments not shown the margin can be a predetermined radial distance in the representation space without regard to the position of the nearest negative sample vector 1204. The margin, whether predetermined or empirically derived as in FIG. 12a, serves the objective of balancing contrastive loss while maintaining anisotropy by limiting the extent to which negative sample vectors are pushed.

With the margin empirically established in FIG. 12a, FIG. 12b depicts subsequently expanding Rᵢ until it includes the second-nearest positive sample vector 1210. This can be done, for example, by dropout of the nearest positive sample vector 1202 in the neural network 902. In this example, Rₒ is also expanded in order to maintain a constant margin. In alternative embodiments, not depicted, Rₒ can be expanded in a way that varies the margin, such as to vary Rₒ in direct relation to the representation distance from the prompt vector 702.

In this example with a constant margin, expanding Rᵢ results in including five negative sample vectors 1212, 1214, 1216, 1218, 1220 either within the margin or within the expanded Rᵢ. FIG. 12c depicts pushing the negative sample vectors 1212, 1214, 1216, 1218, 1220 radially outward to reposition them in the representation space. The repositioning is shown by the negative data sample vectors depicted in broken circles. This repositioning of the negative sample vectors 1212, 1214, 1216, 1218, 1220 establishes the radial margin M between each of them and the second-nearest positive sample vector 1210. This method can then continue to expand the annular boundary to include the next-nearest positive sample vector and thereby push more negative sample vectors in the minibatch. In this manner, the method smooths the boundary condition between the positive samples and the negative samples and makes the soft prompting for positive sample vectors more robust.

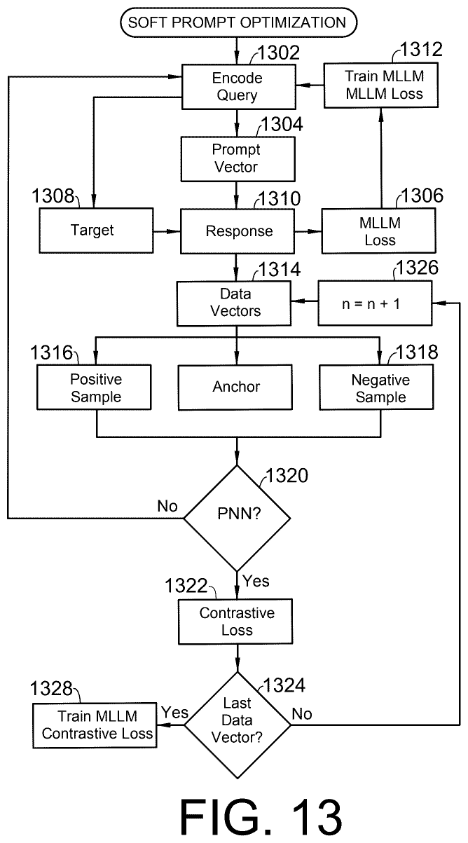

FIG. 13 is a flow chart of a method for soft prompt optimization with an MLLM that is trained on a corpus of unlabeled sample data for natural language classification, consistent with illustrative embodiments. The method includes block 1302 encoding a user query into an encoded soft prompt. Block 1304 embeds the encoded soft prompt into a multidimensional prompt vector in a representation space of the unlabeled sample data. Block 1306 computes MLLM loss by comparing a target 1308 to a response 1310 to the prompt vector from block 1304. Block 1312 trains the MLLM to minimize the MLLM loss from block 1306.

Block 1314 embeds a minibatch of sample data in nearest proximity to the prompt vector from block 1304 into a plurality of multidimensional data vectors in the representation space. Block 1314 further distinguishes positive data samples from negative data samples by inferencing a pairwise comparison of each data vector from block 1314 to a positive sample vector block 1316 and a negative sample vector block 1318. Block 1320 determines whether the nearest neighbor to the prompt vector from block 1304 is a positive data sample (positive nearest neighbor “PNN”). If the determination of block 1320 is no, then control can pass to block 1302 to recode the query for a broader scope of similarity comparison. Otherwise, block 1322 computes contrastive loss in the minibatch of data vectors. Block 1324 increments a counter block 1326 and returns control to block 1314 for the next data vector or passes control to block 1328 which trains the MLLM to minimize the contrastive loss.

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

It is to be appreciated that the computer system (e.g., the specialized computer 101, the SPO engine 180, and/or the processing resources) performs acts in optimizing machine learning that cannot be performed by a human (e.g., is greater than the capability of a single human mind). For example, an amount of data processed, a speed of processing of data and/or data types of the data processed over a certain period of time can be greater, faster and different than an amount, speed and data type that can be processed by a single human mind over the same period of time. The computer system can also be fully operational towards performing one or more other functions while also performing the above-referenced hyperparameter optimization of an ML model. Moreover, ML output generated by computer system can include information that is impossible to obtain manually by a user. For example, an amount of information included in the ML output and/or a variety of information included in the ML output can be more complex than information obtained manually by a user.

Moreover, because at least machine learning optimization is established from a combination of electrical and mechanical components and circuitry, a human is unable to replicate or perform processing performed by the computer system (e.g., specialized computer 101, the SPO engine 180, and resources) disclosed herein. For example, a human is unable to communicate data and/or process data associated with the SPO engine 180 for a given downstream task.

Additionally, the specialized computer 101 significantly improves the operating efficiencies of the computer system by identifying and processing training samples corresponding to different hyperparameter constraints in response to a downstream task. Transmitting custom-tailored hyperparameter training samples to a shared memory as disclosed herein intentionally and significantly eliminates the need to transmit larger volumes of the test data and eliminates multiple processing and copying of the training datasets. This frees up computer system processing overhead and storage capacities to attend to more important processes, generally reducing the overall computational overhead of hyperparameter optimization.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed:

1. An autoencoder computer program product for optimizing machine learning by soft prompting a machine learning language model (“MLLM”) trained on a corpus of unlabeled sample data for natural language classification, the autoencoder computer program product comprising a computer readable storage medium having program instructions embodied therewith, wherein an execution of the program instructions by a computer processor causes a computing device to:
encode a query into a soft computer prompt corresponding to a target response from the MLLM;
embed the soft computer prompt into a multidimensional prompt vector in a representation space of the unlabeled sample data;
embed a minibatch of the unlabeled sample data into a plurality of multidimensional data vectors in the representation space;
determine a contrastive loss from the plurality of multidimensional data vectors in relation to the multidimensional prompt vector in the representation space; and
in response to determining that the contrastive loss is nonzero, then train the MLLM to reduce the contrastive loss.

2. The autoencoder computer program product of claim 1, wherein the execution of the program instructions further causes the computing device to:
inference a response to the soft computer prompt;
determine an MLLM loss by comparing the response to the target response; and
in response to determining the MLLM loss is non-zero, train the MLLM to minimize the MLLM loss.

3. The autoencoder computer program product of claim 1, wherein the encode the query further comprises:
allocate a computer programmable memory to a plurality of tokens;
divide the query into a plurality of query segments;
store each query segment to one of the tokens in the plurality of tokens; and
mask one of the tokens to withhold the corresponding query segment from the soft computer prompt.

4. The autoencoder computer program product of claim 3, wherein the determine the contrastive loss further comprises:
embed a copy of the prompt vector into a positive sample vector in the representation space; and
embed a sample data outside the minibatch into a negative sample vector in the representation space.

5. The autoencoder computer program product of claim 4, wherein the positive sample vector comprises an augmented copy of the prompt vector.

6. The autoencoder computer program product of claim 3, wherein the encode the query further comprises:
mask one of the tokens of the plurality of tokens to form a first encoder configuration;
embed a first soft computer prompt with the first encoder configuration;
set the first soft computer prompt to the prompt vector;
mask a different one of the tokens of the plurality of tokens to form a second encoder configuration;
embed a second soft computer prompt with the second encoder configuration; and
set the second soft computer prompt to a positive sample vector.

7. The autoencoder computer program product of claim 3, wherein the encode the query further comprises:
mask one or more of the tokens of the plurality of tokens to form a first encoder configuration;
embed a first soft computer prompt with the first encoder configuration;
set the first soft computer prompt to the prompt vector; and
mask a different one or more of the tokens of the plurality of tokens to form a second encoder configuration;
embed a second soft computer prompt with the second encoder configuration; and
set the second soft computer prompt to a positive sample vector.

8. The autoencoder computer program product of claim 5, wherein the execution of the program instructions further causes the computing device to:
inference similarity of a selected data vector in the minibatch by a pairwise comparison to the positive sample vector and the negative sample vector; and
in response to determining that the selected data vector is similar to the positive sample vector, set the selected data vector to a positive data sample vector; and
in response to determining that the selected data vector is dissimilar to the positive sample vector, set the selected data vector to a negative data sample vector.

9. The autoencoder computer program product of claim 8, wherein the determine the contrastive loss comprises a predetermined contrastive loss objective for a first positive data sample and a first negative data sample in the minibatch.

10. The autoencoder computer program product of claim 9, wherein the predetermined contrastive loss objective comprises a boundary condition in the representation space for the first positive data sample and the first negative data sample.

11. The autoencoder computer program product of claim 10, wherein the predetermined contrastive loss objective comprises a maximum value between:
zero; and
a contrastive representation state between the first positive data sample, the first negative data sample, and an annular boundary condition around the prompt vector.

12. The autoencoder computer program product of claim 11, wherein the determine the contrastive loss comprises pushing the first negative data sample to establish an annular margin around the prompt vector.

13. An autoencoder apparatus for optimizing machine learning by soft prompting a machine learning language model (“MLLM”) trained on a corpus of unlabeled sample data for natural language classification, the autoencoder apparatus comprising:
an encoder configured to encode a query into a soft computer prompt corresponding to a target response from the MLLM;
a computer readable storage medium having program instructions embodied therewith, wherein an execution of the program instructions by a computer processor causes a computing device to:
encode a query into a soft computer prompt corresponding to a target response from the MLLM;
embed the soft computer prompt into a multidimensional prompt vector in a representation space of the unlabeled sample data;
embed a minibatch of the unlabeled sample data into a plurality of multidimensional data vectors in the representation space;
determine a contrastive loss from the plurality of multidimensional data vectors in relation to the multidimensional prompt vector in the representation space; and
in response to determining that the contrastive loss is nonzero, train the MLLM to reduce the contrastive loss.

14. The autoencoder apparatus of claim 13, wherein the encode the query further comprises:
allocate a computer programmable memory to a plurality of tokens;
divide the query into a plurality of query segments;
store each query segment to one of the tokens in the plurality of tokens; and
mask one of the tokens to withhold the corresponding query segment from the soft computer prompt.

15. The autoencoder apparatus of claim 13, wherein the determine the contrastive loss further comprises:
embed a copy of the prompt vector into a positive sample vector in the representation space; and
embed a sample data outside the minibatch into a negative sample vector in the representation space.

16. The autoencoder apparatus of claim 15, wherein the positive sample vector comprises an augmented copy of the prompt vector.

17. The autoencoder apparatus of claim 14, wherein the execution of the program instructions further causes the computing device to:
mask one or more of the tokens of the plurality of tokens to form a first encoder configuration;
embed a first soft computer prompt with the first encoder configuration;
set the first soft computer prompt to the prompt vector; and
mask a different one or more of the tokens of the plurality of tokens to form a second encoder configuration;
embed a second soft computer prompt with the second encoder configuration; and
set the second soft computer prompt to a positive sample vector.

18. The autoencoder apparatus of claim 17, wherein the execution of the program instructions further causes the computing device to:
inference similarity of a selected data vector in the minibatch by a pairwise comparison to a positive sample vector and a negative sample vector; and
in response to determining that the selected data vector is similar to the positive sample vector, set the selected data vector to a positive data sample vector; and
in response to determining that the selected data vector is dissimilar to the positive sample vector, set the selected data vector to a negative data sample vector.

19. The autoencoder apparatus of claim 18, wherein the determine the contrastive loss comprises pushing a first negative data sample vector to establish an annular margin around the prompt vector.

20. A computer system for optimizing machine learning by soft prompting a machine learning language model (“MLLM”) trained on a corpus of unlabeled sample data for natural language classification, the computer system having a processor, a computer-readable memory, a computer-readable tangible storage device, and program instructions stored on the computer-readable storage device for execution by a processor via the computer-readable memory, wherein the computer system is configured to perform a method, comprising:
encode a query into a soft computer prompt corresponding to a target response from the MLLM;
embed the soft computer prompt into a multidimensional prompt vector in a representation space of the unlabeled sample data;
embed a minibatch of the unlabeled sample data into a plurality of multidimensional data vectors in the representation space;
determine a contrastive loss from the plurality of multidimensional data vectors in relation to the multidimensional prompt vector in the representation space; and
in response to determining that the contrastive loss is nonzero, then train the MLLM to reduce the contrastive loss.
